(19) United States
(12) Patent Application Publication
(10) Pub. No.: US 2015/0342146 A1
(43) Pub. Date: Dec. 3, 2015

(54) ILLUMINATED BALL THROWING APPARATUS AND METHOD THEREOF

(71) Applicant: DOUBLE WAG HOLDINGS, LLC, Fort Lauderdale, FL (US)

(72) Inventor: Matthew Tucker, Fort Lauderdale, FL (US)

(21) Appl. No.: 14/727,629

(22) Filed: Jun. 1, 2015

Related U.S. Application Data
(60) Provisional application No. 62/005,790, filed on May 30, 2014.

(51) Int. Cl. A01K 15/02; A63B 65/12

(52) U.S. Cl. CPC A01K 15/027; A01K 15/025; A63B 65/122

(57) ABSTRACT

A glow in the dark throwing apparatus comprises an elongated shaft, the elongated shaft includes a lower handle portion extending to at least one flexible upper neck, integrally formed at the distal end of the at least one upper neck is a glow-in-the-dark first ball receivable portion.

### CROSS-REFERENCE TO RELATED APPLICATION

This application is related to and claims benefit to U.S. Provisional Patent Application Ser. No. 62/005790, filed May 30, 2014, entitled Multiple Ball Throwing Apparatus and Method Thereof, the entirety of which is incorporated herein by reference.

### FIELD OF THE INVENTION

The present invention relates to a throwing apparatus, and more in particularly to an apparatus designed to play the game of fetch in the dark with one or animals.

### BACKGROUND OF THE INVENTION

Dogs generally enjoy spending their days chasing objects, such as balls, thrown by a person. Because dogs run at such quick speeds, it is difficult for a person to throw a ball far enough to wear out the energy of the dogs and to match the closing speed of the dogs.

In addition to a person's physical limitations, the ball is typically returned to the person only to be coated in dog saliva, which is not pleasant to the touch, nor sanitary. Further, back injuries to the person can result from the constant bending over to pick up the ball, as well as shoulder injuries from the repetitive throwing motion.

Another problem that exists is the possibility of a toy possessive dog biting the person when reaching for the ball.

The prior art ball throwing apparatus fail to solve a number of problems. For example, the prior art fails to provide an apparatus that may be used at night. The present colors of the device prevent visibility of the ball launcher when it is swung in dark conditions, which is dangerous to other bystanders and animals alike.

Furthermore, in daylight hours, dogs begin to run for the ball upon seeing the ball throwing apparatus being swung. However, in dark and/or night time conditions the one or more dogs commonly do not see the swing of the prior art ball throwing apparatus because the prior art is not visible in dark conditions. In turn, one or more dogs will not begin chasing the object released from the ball throwing apparatus. Because the dogs do not immediately begin chasing the balls, the one or more dogs lose track of the ball in dark conditions and one or more balls or other objects, which ultimately become lost or difficult to find.

Yet further, dogs have difficulty returning to their owner or other person in dark and/or night time conditions because the owner or other person is similarly dark. A need therefore exists for a ball throwing apparatus that is lit to allow the dog to easily find and return to its owner or other persons.

Yet further, the prior art ball throwing apparatus does not allow a person, such as the thrower or an observer, to gauge the speed at which the ball throwing apparatus is swing in dark and/or night time conditions. Thus a further need exists for a ball throwing apparatus that has characteristics that makes it easy for the thrower and observers to gauge the speed of the ball throwing apparatus in dark and/or night time conditions.

Additionally, when playing fetch with two dogs with the prior art, the person only has the ability to throw a single ball or other like object at a time. This results in multiple dogs chasing down the same ball. In some cases, toy possessive dogs may fight over that single ball. In other cases, the slower weaker dog unable to get to the ball first develops insecurities and reduced levels of self-confidence.

In many instances, dog owners have multiple dogs of varying sizes. For example, in the dog community, it would not be uncommon for a dog owner to have a very large Boxer and a small Jack Russell Terrier. Because of the differences in the size of dogs, it has been found using the prior art that smaller dogs may not chase the ball due to either the large size of the ball or due to the extended distance that the ball is launched.

In other instances, the prior art allows for two or more dogs to each chase their own ball one at a time. For example, while one dog is chasing one ball, the throwing apparatus can loaded by the person with another ball. Then the person can throw the second ball for the second dog to chase. However, this results in the person having to make twice as many throwing motions as the person would otherwise have to if two or more balls could be thrown substantially simultaneously and in one throwing motion. And throwing a ball one at a time increases the use of the person's shoulder, which over time increases the risk of developing shoulder injuries.

U.S. Pat. No. 6,076,829 falls short of solving at least the problems identified herein because it cannot be safely used at night.

Accordingly, there is a need in the art for an apparatus capable of throwing multiple balls, or like objects, during a single throw and/or simultaneously, as well as being useful during dark and/or nighttime conditions.

### SUMMARY OF THE INVENTION

The present invention advantageously provides a ball throwing apparatus that comprises a unitary elongated shaft having a longitudinal axis and opposite distal and proximal ends. A first at least partially spherical structure carried by said distal end. A second at least partially spherical structure carried by said distal end.

According to an embodiment of the present invention, another object the distal end defines a first upper neck and a second upper neck, the first upper neck carrying the first at least partially spherical structure, the second upper neck carrying the second at least partially spherical structure.

According to an embodiment of the present invention, another object the distal end defines a first upper neck, the upper neck carrying the first and second at least partially spherical structures.

According to an embodiment of the present invention, another object the first and second at least partially spherical structure are positioned side-by-side.

According to an embodiment of the present invention, another object the first and second at least partially spherical structure are aligned about a rear vertical curve along the elongated shaft.

According to an embodiment of the present invention, another object the first at least partially spherical structure is offset about the elongated shaft in relation to the second at least partially spherical structure along the rear vertical curve.

According to an embodiment of the present invention, another object the first at least partially spherical structure is operable to snap-fit a first sized ball, wherein the second at least partially spherical structure operable to snap-fit a second sized ball.

According to an embodiment of the present invention, another object the first at least partially spherical structure operable to snap-fit a standard sized tennis ball, wherein the second at least partially spherical structure operable to snap-fit a ball being one of larger and smaller than a substantially standard tennis ball.

According to an embodiment of the present invention, another object the first at least partially spherical structure having a first launch angle, wherein the second at least partially spherical structure having a second launch angle.

According to an embodiment of the present invention, another object a ball throwing apparatus comprises a unitary elongated shaft having a longitudinal axis and opposite distal and proximal ends, a first and second ball receivable portion carried by the distal end, the first and second ball receivable portion each optionally operable to capture a ball.

According to an embodiment of the present invention, another object the distal end defining a first upper neck and a second upper neck, the first upper neck carrying the first ball receivable portion, the second upper neck carrying the second ball receivable portion.

According to an embodiment of the present invention, another object the distal end defining a first upper neck, the upper neck carrying the first and second ball receivable portions.

According to an embodiment of the present invention, another object the first and second ball receivable portions are positioned side-by-side.

According to an embodiment of the present invention, another object the first and second ball receivable portions are aligned about a rear vertical curve along the elongated shaft.

According to an embodiment of the present invention, another object the first ball receivable portion is offset about the elongated shaft in relation to the second ball receivable portion.

According to an embodiment of the present invention, another object the first ball receivable portion operable to snap-fit a first sized ball, wherein the second ball receivable portion operable to snap-fit a second sized ball.

According to an embodiment of the present invention, another object the first ball receivable portion operable to snap-fit a standard sized tennis ball, wherein the second ball receivable portion operable to snap-fit a ball being one of larger and smaller than a substantially standard tennis ball.

According to an embodiment of the present invention, another object the first ball receivable portion positioned having a first launch angle, wherein the second ball receivable portion having a second launch angle different from the first launch angle.

According to an embodiment of the present invention, an object is to provide an apparatus for optionally throwing two or more balls during a single swing.

According to an embodiment of the present invention, an object is to provide an apparatus for simultaneously throwing two balls for the enjoyment of at least two dogs.

According to an embodiment of the present invention, an object is to provide an apparatus for grasping or otherwise gripping two balls at the distal end of a shaft.

According to an embodiment of the present invention, an object is to provide an apparatus for night time use that glows in the dark or is otherwise illuminated. The glow in the dark elements of the apparatus allow for one or more dogs to track the swing of the apparatus, and further allow one or more dogs to find their way back to the apparatus.

According to an embodiment of the present invention, an object is to provide photoluminescent characteristics of the apparatus for throwing balls or other objects.

According to an embodiment of the present invention, an object is to provide an apparatus that has characteristics that makes it easy for the thrower and observers to gauge the speed of the ball throwing apparatus in dark and/or night time conditions.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a perspective view of a multiple ball throwing apparatus in accordance with the principles of the present embodiment;

FIG. 2 is a front view of the multiple ball throwing apparatus of FIG. 1;

FIG. 3 is left side view of the multiple ball throwing apparatus of FIG. 1;

FIG. 4 is a right side view of the multiple ball throwing apparatus of FIG. 1;

FIG. 5 is a top view of the multiple ball throwing apparatus of FIG. 1;

FIG. 6 is a bottom view of the multiple ball throwing apparatus of FIG. 1;

FIG. 7 is a perspective view of a multiple ball throwing apparatus having multiple stacked heads in accordance with the principles of the present embodiment;

FIG. 8 is a perspective view of a multiple ball throwing apparatus with a single head configured to simultaneously launch at least two balls in the same throwing motion in accordance with the principles of the present invention;

FIG. 9 is a perspective view of a multiple ball throwing apparatus having at least two sized side-by-side heads in accordance with the principles of the present invention;

FIG. 10 is a front view of the multiple ball throwing apparatus of FIG. 9;

FIG. 11 is a left side view of the multiple ball throwing apparatus of FIG. 9;

FIG. 12 is a right side view of the multiple ball throwing apparatus of FIG. 9;

FIG. 13 is a top view of the multiple ball throwing apparatus of FIG. 9;

FIG. 14 is a bottom view of the multiple ball throwing apparatus of FIG. 9;

FIG. 15 is a perspective view of a multiple ball throwing apparatus having at least two ball receivable structures optionally operable to capture and simultaneously throw two balls in accordance with the principles of the present embodiment;

FIG. 16 is a front view of the multiple ball throwing apparatus of FIG. 15;

FIG. 17 is left side view of the multiple ball throwing apparatus of FIG. 15;

FIG. 18 is a right side view of the multiple ball throwing apparatus of FIG. 15;

FIG. 19 is a top view of the multiple ball throwing apparatus of FIG. 15;

FIG. 20 is a bottom view of the multiple ball throwing apparatus of FIG. 15; and

FIG. 21 is a side view of a multiple ball throwing apparatus having one or more ball storage portions.

### DETAILED DESCRIPTION OF THE INVENTION

The present invention advantageously provides a multiple ball throwing apparatus and methods associated thereof.

Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, simultaneous release of two or more ball typically means releasing the balls during single throwing motion.

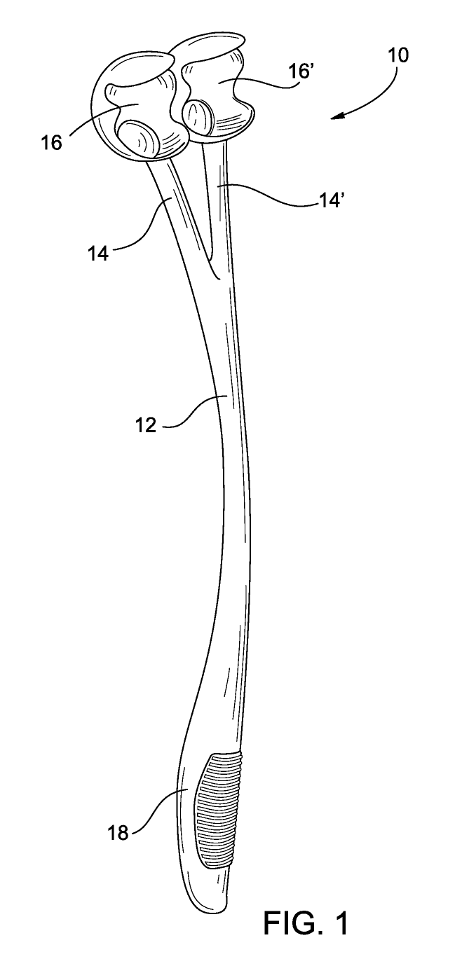

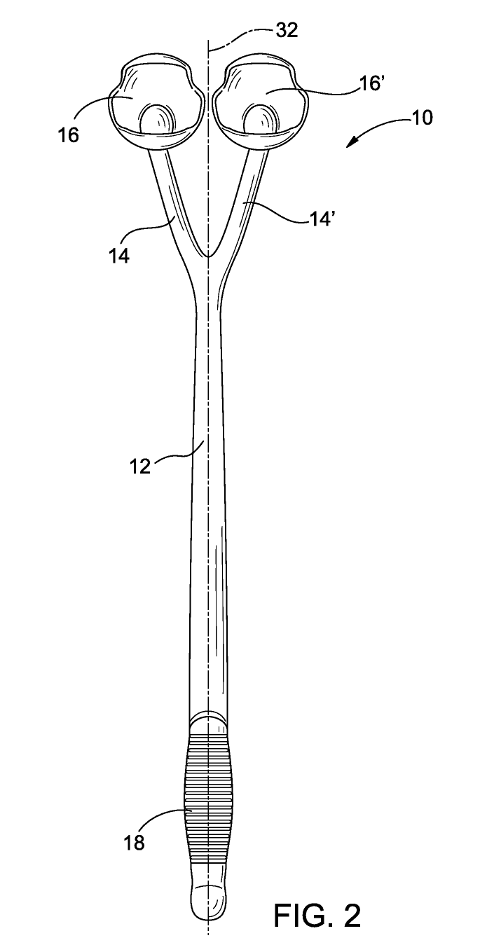

Referring now to the drawings figures in which like reference designators refer to like elements. FIG. 1 shows an exemplary side-by-side multiple ball throwing apparatus constructed in accordance with the principles of the present invention and designated generally as multiple ball throwing apparatus 10. The multiple ball throwing apparatus 10 comprises an elongated shaft 12. The elongated shaft 12 includes a lower handle portion 18 extending to a first flexible upper neck 14 and a second flexible upper neck 14′. Integrally formed at the distal end of the first upper neck 14 is a first at least partially spherical structure 16. Integrally formed at the distal end of the second upper neck 14′ is a second at least partially spherical structure 16′.

The first and second at least partially spherical structures 16, 16′ are each designed to snap-fit around a standard tennis ball.

In one embodiment, the first at least partially spherical structure 16 is at least a half-spherical structure.

In one embodiment, the second at least partially spherical structure 16 is at least a half-spherical structure.

In one embodiment, the first and second upper necks 14, 14′ are side-by-side.

In one embodiment, the first and second at least partially spherical structures 16, 16′ are side-by-side.

The elongated shaft 12 provides assistance for optionally throwing two or more balls a great distance during operation. While the instant embodiment provides for two spherical structures 16, 16′ for holding two balls, the device may optionally be used with only one ball at a time by placing a ball in only one of the first and second at least partially spherical structures 16, 16′.

In one embodiment, the elongated shaft 12 allows a user to pickup balls without contacting dog saliva.

The elongated shaft 12 is made of a single curved piece of resilient lightweight material, such as polypropylene plastic. The elongated shaft 12 should have memory to maintain its form between throws.

In one embodiment, the first and second upper necks 14, 14′ is stiff for acting as a spring when engaging multiple balls on the ground and when simultaneously throwing multiple balls.

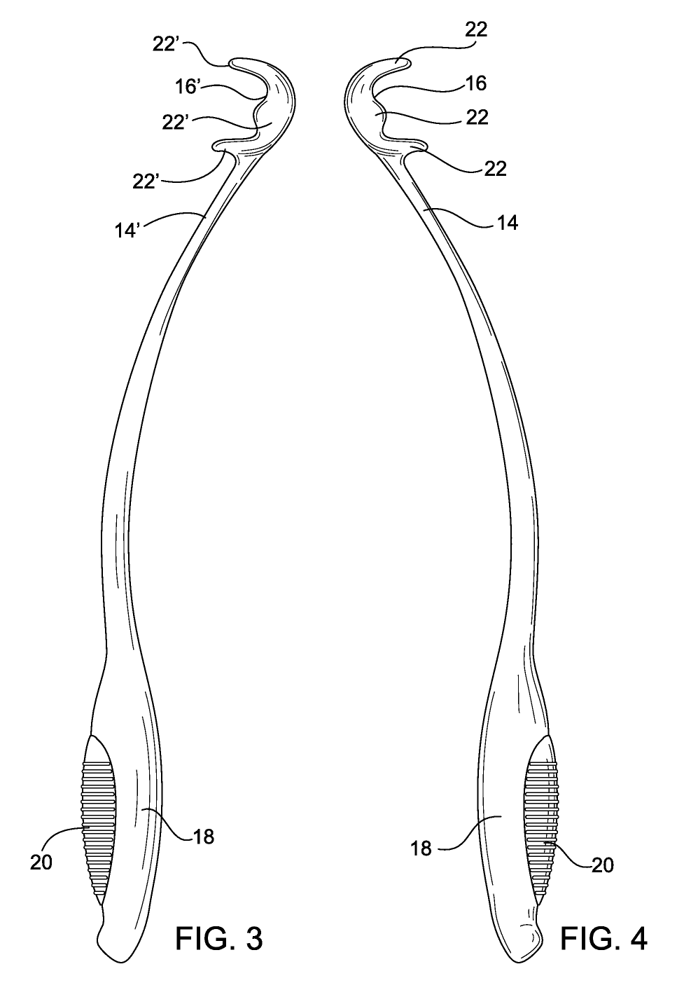

Referring now to FIGS. 3-4, an embodiment is shown where the first and second upper necks 14, 14′ are tapered. The handle 18 includes features 20 for improving gripping.

In one embodiment, the at least partially spherical structures 16, 16′ include an inner radius equal to or slightly smaller than the outer radius of a tennis ball.

Optionally, each of the at least partially spherical structures 16, 16′ includes a mouth having flexible lips 22, 22′ that curve and follow the outer radius of a standard tennis ball. At least some of the flexible lips 22, 22′ extend past the mid-axis of the ball when the ball is attached inside the at least partially spherical structures 16, 16′.

In one embodiment, the length of the elongated shaft 12 varies between 10 inches to 28 inches.

In one embodiment, each of the at least partially spherical structures 16, 16′ are made of identical material to the shaft 12.

In one embodiment, the shaft 12 and the first and second spherical structures 16, 16′ are injection molded in one process and simultaneously.

Referring now to FIGS. 3-6, the shaft 12 is illustrated as curved in a slightly rearward direction.

In one embodiment, the first and second spherical structures 16, 16′ are formed about the upper necks 14, 14′, respectively, having a substantially identical launch angle.

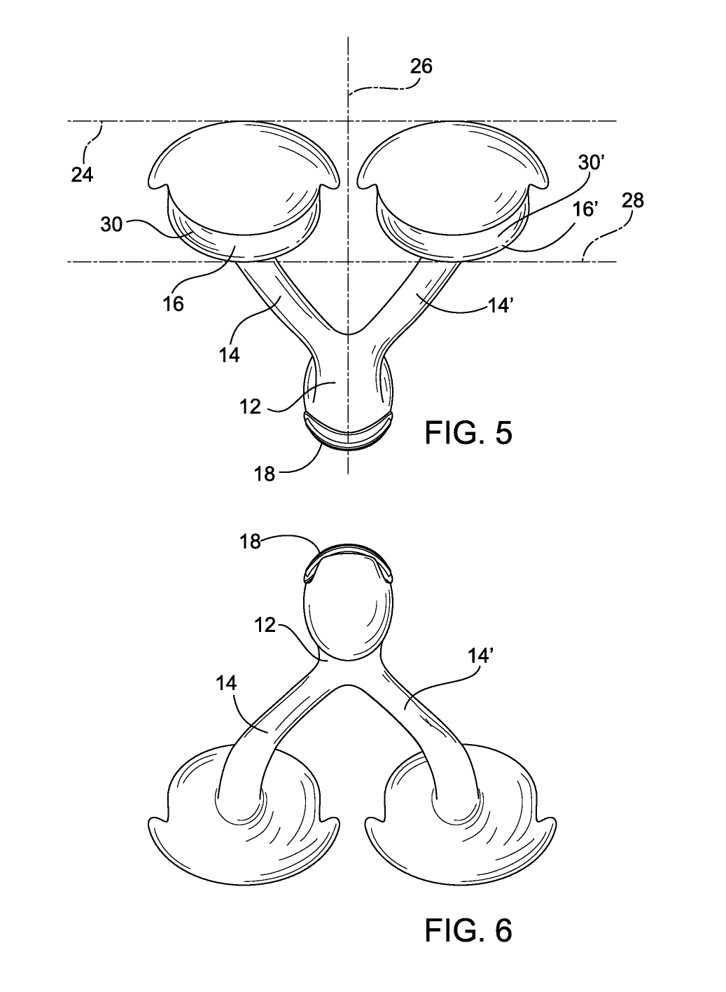

Still referring to FIGS. 3-6, the first and second spherical structures 16, 16′ are positioned latitudinally side-by-side as illustrated by line 24 (See FIG. 5).

In an embodiment, the first and second spherical structures 16, 16′ positioned rear of the handle 18 when viewed from above (See FIG. 5).

In an embodiment, the first and second spherical structures 16, 16′ are each positioned offset from a longitudinally extending center line 26 (See FIG. 5).

In an embodiment, the first and second spherical structures 16, 16′ are each positioned having a mouth 30, 30′ opening along a latitudinally extending line 28 when viewed from above (See FIG. 5).

In one embodiment, each of the first and second spherical structures 16, 16′ having a mouth 30, 30′ that opens being aligned approximately 5 degrees forward and approximately 33 degrees behind the longitudinal axis of the elongated shaft, and having at least one of the first and second spherical structures 16, 16′ offset from a central longitudinally extending axis 26 and offset from a vertically extending axis 32 (See FIG. 5).

In one embodiment, the multiple ball throwing apparatus 10 is symmetrical in all regards, regardless of slight variations in the drawing figures that might suggest otherwise. In a particular embodiment, the elongated shaft 12, and specifically the first flexible upper neck 14 in relation to the second flexible upper neck 14′ are symmetrical.

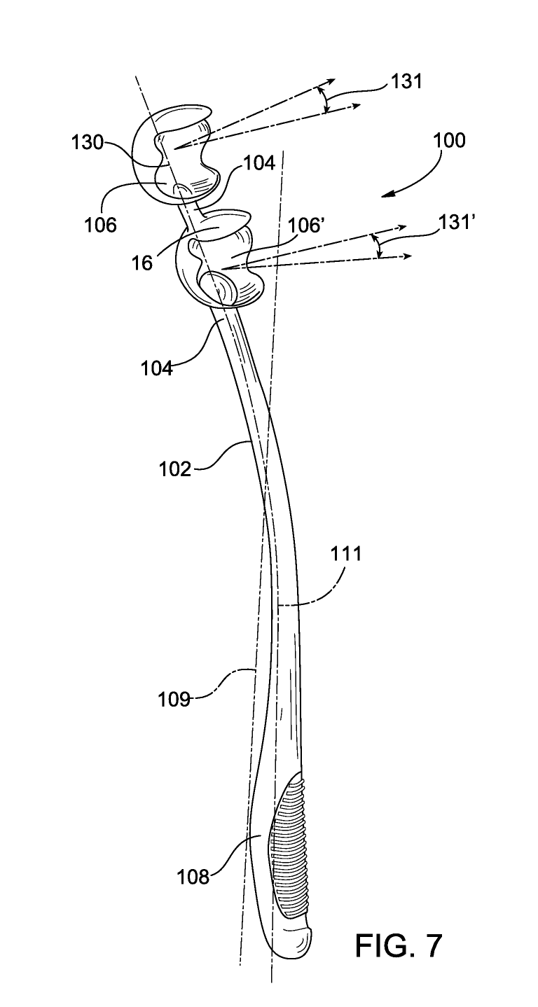

Referring now to FIG. 7, an exemplary inline multiple ball throwing apparatus constructed in accordance with the principles of the present invention and designated generally as multiple ball throwing apparatus 100 is shown. The multiple ball throwing apparatus 100 comprises an elongated shaft 102. The elongated shaft 102 includes a lower handle portion 108 extending to an upper neck 104. Integrally formed at the distal end of the upper neck 104 is a first at least partially spherical structure 106. Integrally formed about the upper neck 104 is a second at least partially spherical structure 106′. The spherical structures 106, 106′ each having a mouth 130, 130′ configured for optionally capturing and simultaneously releasing at least two tennis balls, the spherical structures 106, 106′ positioned rear of the handle portion 108, as illustrated by line 109.

Still referring to FIG. 7, the spherical structures 106, 106′ are stacked vertically along curved line 111. While the instant embodiment shows substantially the same size spherical structures 106, 106′ configured to grip and simultaneously release a standard sized tennis ball, it is contemplated and within the spirit and scope of the present invention to adjust the size of one or both of the spherical structures 106, 106′ for gripping non-standard sized balls that are smaller or larger than a typical tennis ball. Additionally, while the launch angle of the spherical structures 106, 106′ are at least substantially the same, it is contemplated and within the spirit and scope of the present invention to alter the launch angle 131 by altering the position of the mouth 130, 130′ in relation to the upper neck 104.

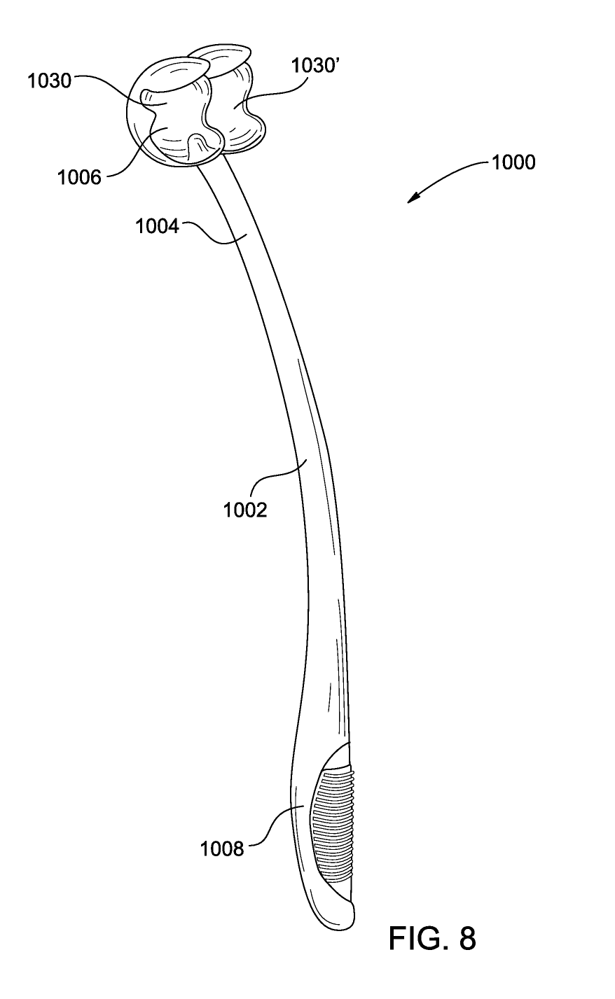

Referring now to FIG. 8, shows an exemplary multiple ball throwing apparatus constructed in accordance with the principles of the present embodiment of the invention and designated generally as multiple ball throwing apparatus 1000. The multiple ball throwing apparatus 1000 comprises an elongated shaft 1002. The elongated shaft 1002 includes a lower handle portion 1008 extending to a flexible upper neck 1004. The flexible upper neck 1004 may be tapered for increasing the whip during throwing actions of the apparatus. Integrally formed at the distal end of the upper neck 1004 is multiple ball receivable portion 1006, which is capable of gripping two balls, the multiple ball receivable portion 1006 has a concaved inner surface. The multiple ball receivable portion 1006 includes at least two mouths 1030, 1030′ each operable to grip a tennis ball.

In one embodiment, the first and second mouths 1030, 1030′ are each designed and sized to snap-fit around standard tennis balls.

In one embodiment, one of the mouths 1030, 1030′ are designed and sized to snap-fit around a standard tennis ball and one of the mouths 1030, 1030′ are designed and sized to snap-fit around a non-standard tennis ball.

In one embodiment, each of the first and second at ball receivable portions 1006, 1006′ are designed to snap-fit around a non-standard sized tennis ball.

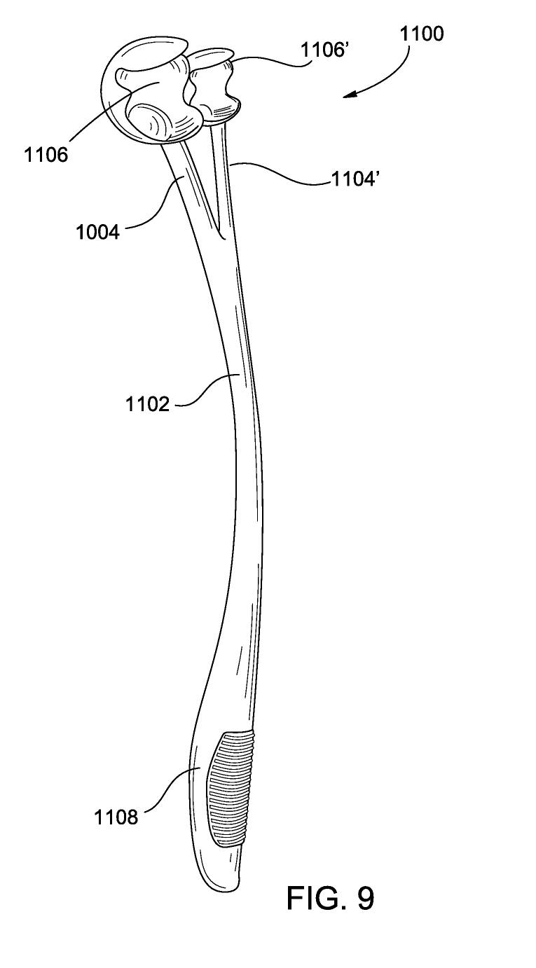

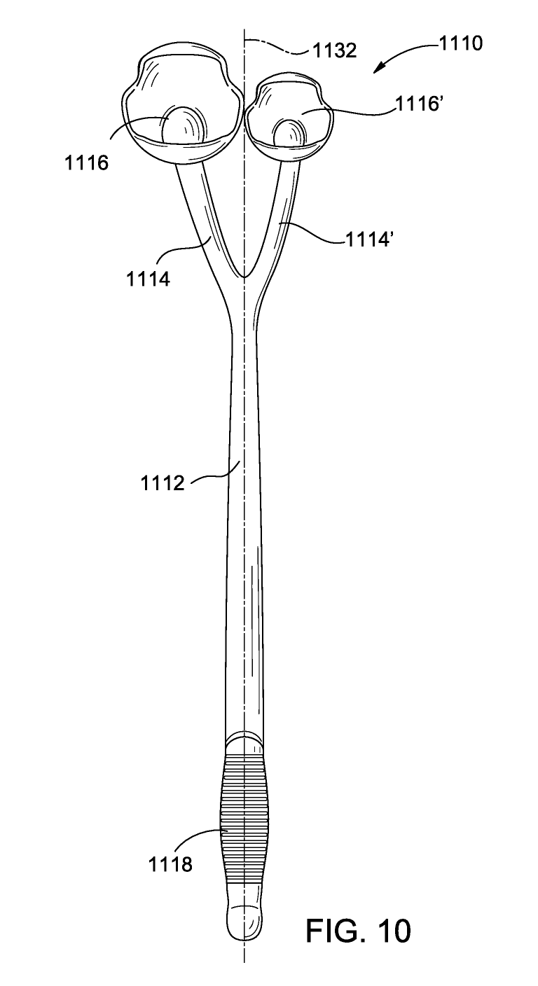

Referring now to FIGS. 9-14, a multiple ball throwing apparatus 1110 is shown. The multiple ball throwing apparatus 1110 comprises an elongated shaft 1112. The elongated shaft 1112 includes a lower handle portion 1118 extending to a first flexible upper neck 1114 and a second flexible upper neck 1114′. Integrally formed at the distal end of the first upper neck 1114 is a first at least partially spherical structure 1116. Integrally formed at the distal end of the second upper neck 1114′ is a second at least partially spherical structure 1116′.

The first and second at least partially spherical structures 1116, 1116′ are designed to snap-fit around a substantially standard tennis ball and a substantially non-standard sized tennis ball.

In one embodiment, the first at least partially spherical structure 1116 is at least a half-spherical structure.

In one embodiment, the second at least partially spherical structure 1116 is at least a half-spherical structure.

In one embodiment, the first and second upper necks 1114, 1114′ are side-by-side. In one embodiment, the necks 1114, 1114′ are symmetrical.

In one embodiment, the first and second at least partially spherical structures 1116, 1116′ are side-by-side.

The elongated shaft 1112 provides assistance for optionally throwing two or more balls a great distance during operation. While the instant embodiment provides for two spherical structures 1116, 1116′ for holding two balls, the device may optionally be used with only one ball at a time by placing a ball in only one of the first and second at least partially spherical structures 1116, 1116′.

In one embodiment, the elongated shaft 1112 allows a user to pickup balls without contacting dog saliva.

The elongated shaft 1112 is made of a single curved piece of resilient lightweight material, such as polypropylene plastic. The elongated shaft 1112 should have memory to maintain its form between throws.

In one embodiment, the first and second upper necks 1114, 1114′ is stiff for acting as a spring when engaging multiple balls on the ground and when optionally simultaneously throwing multiple balls.

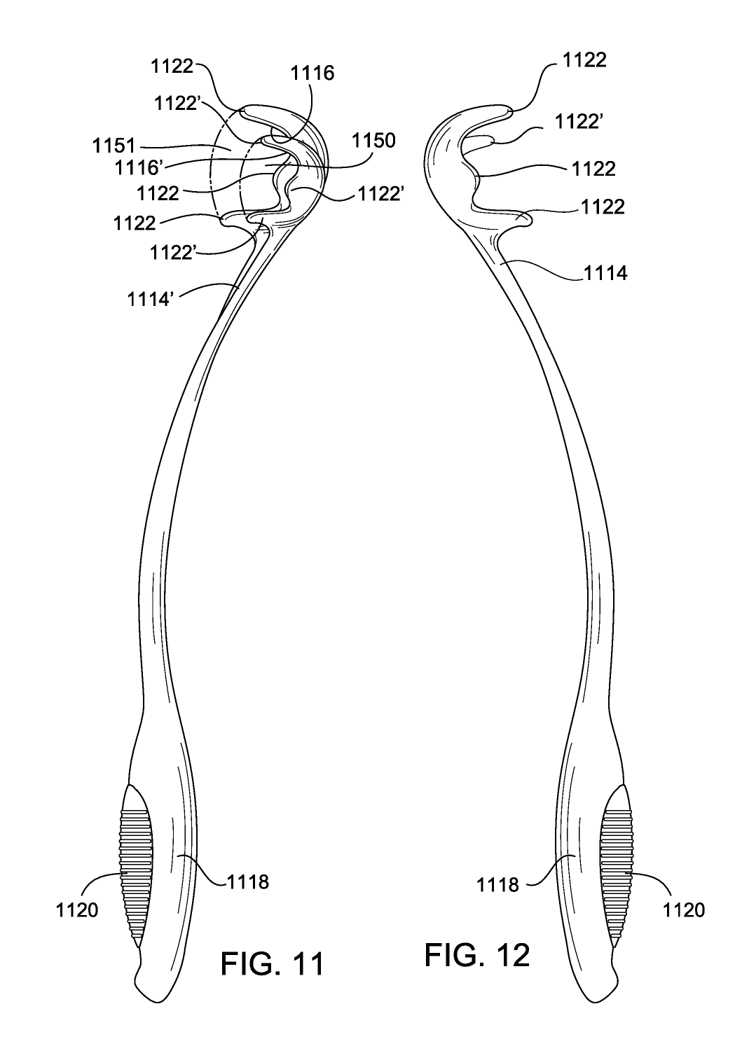

Referring now to FIGS. 11-12, an embodiment is shown where the first and second upper necks 1114, 1114′ are tapered. The handle 1118 includes features 1120 for improving gripping. Two sized tennis balls (one being standard sized and shape and one being non-standard sized) are shown for exemplary purposes.

In one embodiment, the at least partially spherical structures 1116, 1116′ include an inner radius equal to or slightly smaller than the outer radius of a tennis ball.

Optionally, each of the at least partially spherical structures 1116, 1116′ includes a mouth having flexible lips 1122, 1122′ that curve and follow the outer radius of a standard tennis ball. At least some of the flexible lips 1122, 1122′ extend past the mid-axis of the ball when the ball is attached inside the at least partially spherical structures 1116, 1116′.

In one embodiment, the length of the elongated shaft 1112 as constructed varies between 10 inches to 28 inches.

In one embodiment, each of the at least partially spherical structures 1116, 1116′ are made of identical material to the shaft 1112.

In one embodiment, the shaft 1112 and the first and second spherical structures 1116, 1116′ are injection molded in one process and simultaneously.

Referring now to FIGS. 11-14, the shaft 1112 is illustrated as curved in a slightly rearward direction.

In one embodiment, the first and second spherical structures 1116, 1116′ are formed about the upper necks 1114, 1114′, respectively, having a substantially identical launch angle.

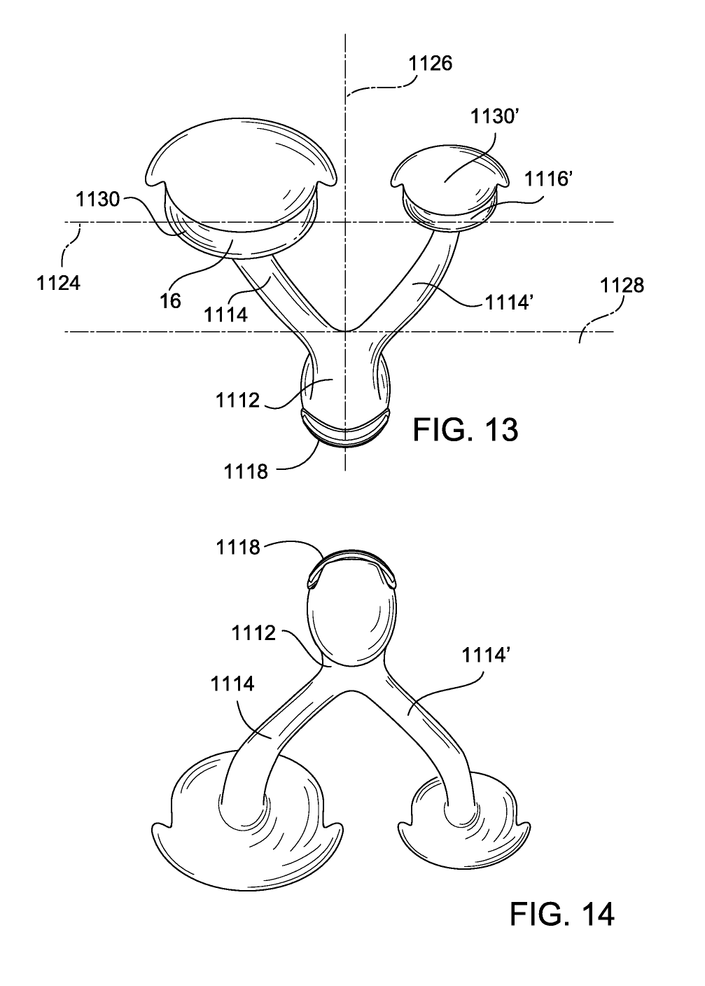

Still referring to FIGS. 11-14, the first and second spherical structures 1116, 1116′ are positioned latitudinally side-by-side as illustrated by line 1124 (See FIG. 13).

In an embodiment, the first and second spherical structures 1116, 1116′ positioned rear of the handle 1118 when viewed from above (See FIG. 13).

In an embodiment, the first and second spherical structures 1116, 1116′ are each positioned offset from a longitudinally extending center line 1126 (See FIG. 5).

In an embodiment, the first and second spherical structures 1116, 1116′ are each positioned having a mouth 1130, 1130′ opening along a latitudinally extending line 1128 when viewed from above (See FIG. 13).

In one embodiment, each of the first and second spherical structures 1116, 1116′ having a mouth 1130, 1130′ that opens being aligned approximately 5 degrees forward and approximately 33 degrees behind the longitudinal axis of the elongated shaft, and having at least one of the first and second spherical structures 1116, 1116′ offset from a central longitudinally extending axis 1126 and offset from a vertically extending axis 1132.

In one embodiment, the multiple ball throwing apparatus 1110 is symmetrical in all regards, except for the size of the spherical structures 1116, 1116′, regardless of slight variations in the drawing figures that might suggest otherwise. In a particular embodiment, the elongated shaft 1112, and specifically the first flexible upper neck 1114 in relation to the second flexible upper neck 1114′ are symmetrical.

Any of the spherical structures disclosed herein may optionally be formed of, or coated with, glow in the dark material.

Any of the multiple ball throwing apparatus disclosed herein may optionally include a battery receiving portion, a light portion, and a power mechanism for switching between an on and off position.

One particular embodiment of any of the multiple ball throwing apparatus disclosed herein is optionally formed from as a single piece of plastic.

One particular embodiment of any of the multiple ball throwing apparatus disclosed herein is optionally formed from as a single piece of plastic and injection molded.

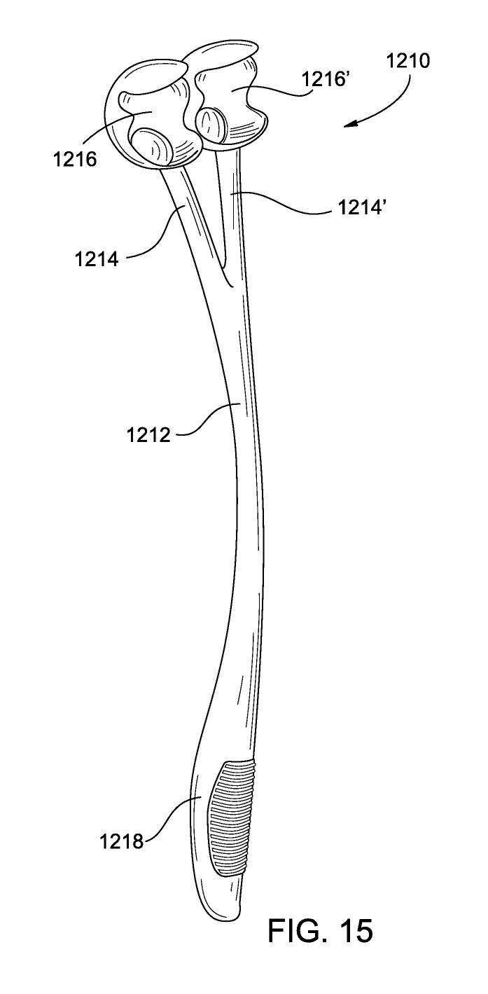

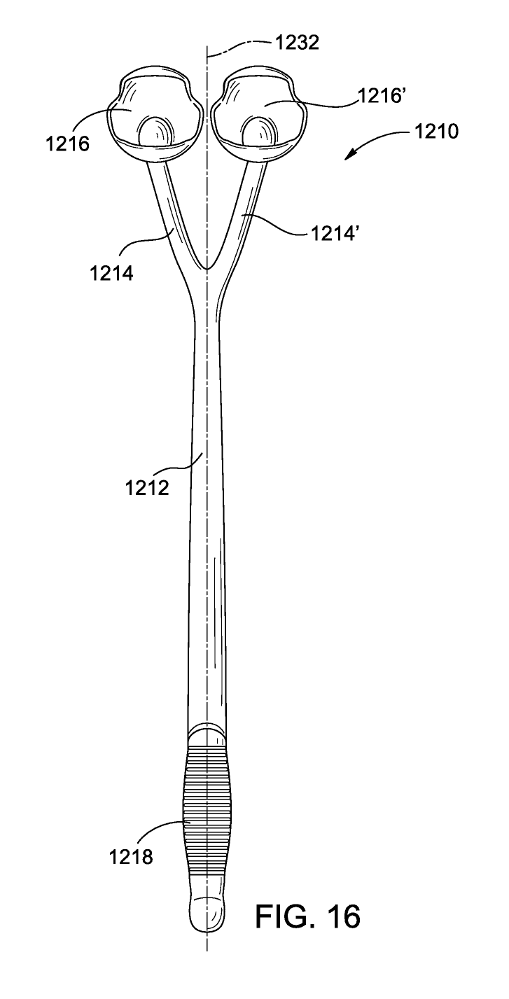

FIGS. 15-20 show an exemplary side-by-side multiple ball throwing apparatus constructed in accordance with the principles of the present invention and designated generally as multiple ball throwing apparatus 1210. The multiple ball throwing apparatus 1210 comprises an elongated shaft 1212. The elongated shaft 1212 includes a lower handle portion 1218 extending to a first flexible upper neck 1214 and a second flexible upper neck 1214′. Integrally formed at the distal end of the first upper neck 1214 is a first ball receivable structure 1216. Integrally formed at the distal end of the second upper neck 1214′ is a second ball receivable structure 1216′.

In one embodiment, the first and second ball receivable structures 1216, 1216′ are each designed to snap-fit around, or otherwise grip a standard tennis ball.

In one embodiment, the first ball receivable structure 1216 designed to snap-fit around, or otherwise grip a standard tennis ball, the second ball receivable structure designed to snap-fit around, or otherwise grip at least one non standard sized tennis ball.

In one embodiment, the first and second ball receivable structures 1216, 1216′ are each designed to snap-fit around, or otherwise grip a non-standard sized and/or shaped tennis ball.

In one embodiment, the first and second ball receivable structures 1216, 1216′ are at least a partially spherical structure.

In one embodiment, the first and second ball receivable structure are not spherical in shape, but instead some other shape capable of snap-fitting or otherwise gripping a ball of the type disclosed herein.

In one embodiment, the first and second ball receivable structures 1216, 1216′ are at least a half-spherical structure.

In one embodiment, the first and second upper necks 1214, 1214′ are side-by-side.

In one embodiment (not shown), the first and second upper necks 1214, 1214′ are positioned inline, as opposed to side-by-side.

In one embodiment, the first and second ball receivable structures 1216, 1216′ are side-by-side.

The elongated shaft 1212 provides assistance for optionally throwing two or more balls a great distance during operation. While the instant embodiment provides for two ball receivable structures 1216 , 1216′ for holding two balls, the device may optionally be used with only one ball at a time by placing a ball in only one of the first and second ball receivable structures 1216, 1216′.

In one embodiment, the elongated shaft 1212 allows a user to pickup balls without contacting dog saliva.

In one embodiment, the elongated shaft 1212 is made of a single curved piece of resilient lightweight material, such as polypropylene plastic.

In one embodiment (not shown), the elongated shaft 1212 is formed substantially straight of a resilient lightweight material, such as polypropylene plastic.

The elongated shaft 1212 should have memory to maintain its form between throws.

In one embodiment, the first and second upper necks 1214, 1214′ are stiff for acting as a spring when engaging multiple balls on the ground and when simultaneously throwing multiple balls.

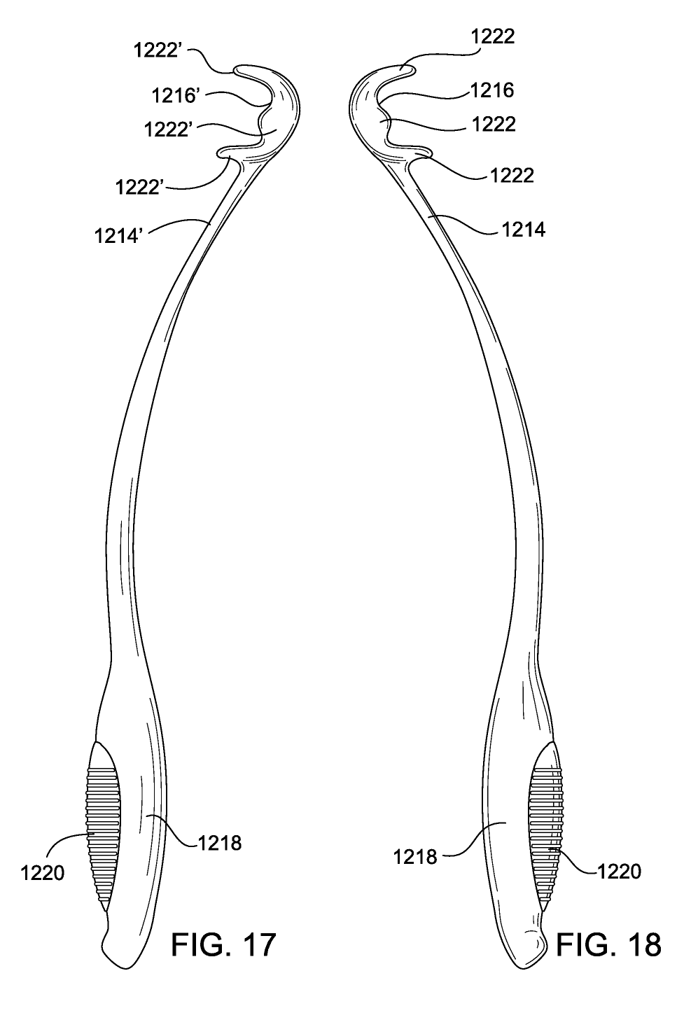

Referring now to FIGS. 17-18, an embodiment is shown where the first and second upper necks 1214, 1214′ are tapered towards the ball receivable structures 1216, 1216′. The handle 1218 includes features 1220 for improving gripping.

In one embodiment, the ball receivable structures 1216, 1216′ include an inner radius equal to or slightly smaller than the outer radius of a tennis ball.

Optionally, each of the ball receivable structures 1216, 1216′ include a mouth that has one or more flexible lips 1222, 1222′ that curve and follow the outer radius of a standard tennis ball. At least some of the flexible lips 1222, 1222′ extend past the mid-axis of a ball when the ball is optionally attached inside the ball receivable structures 1216, 1216′.

In one embodiment, the length of the elongated shaft 1212 varies between 10 inches to 28 inches.

In one embodiment, each of the ball receivable structures 1216, 1216′ are made of identical material to the shaft 1212.

In one embodiment, the shaft 1212 and the at least two ball receivable structures 1216, 1216′ are injection molded in one process and simultaneously to form a single structure. Additional components can then later be added, such as additional grips, and other aesthetic pieces.

Referring now to FIGS. 17-20, the shaft 1212 is illustrated as curved in a slightly rearward direction. However, the amount of curve provided in this embodiment is optional and instead the shaft 1212 may have more or less curve as desired or necessary.

In one embodiment, the first and second ball receivable structures 1216, 1216′ are formed about the upper necks 1214, 1214′, respectively, having a substantially identical launch angle.

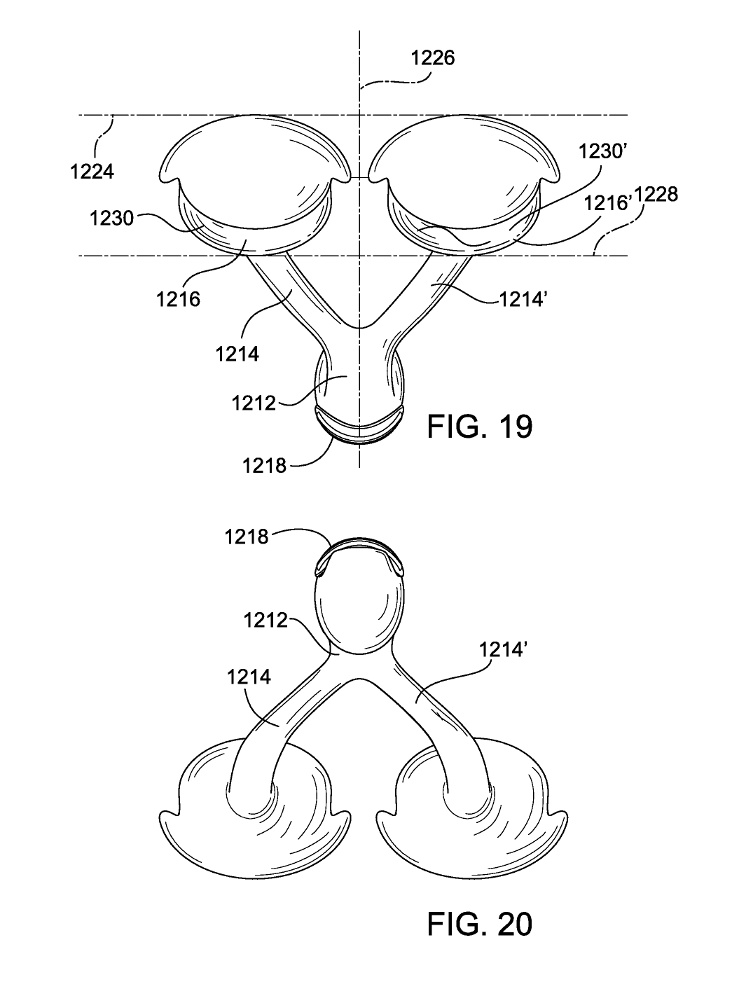

Still referring to FIGS. 17-20, the first and second ball receivable structures 1216, 1216′ are positioned latitudinally side-by-side as illustrated by line 1224 (See FIG. 19).

In an embodiment, the first and second ball receivable structures 1216, 1216′ positioned rear of the handle 1218 when viewed from above.

In an embodiment, the first and second ball receivable structures 1216, 1216′ are each positioned offset from a longitudinally extending center line 1226 (See FIG. 5).

In an embodiment, the first and second ball receivable structures 1216, 1216′ are each positioned having a mouth 1230, 1230′ opening along a latitudinally extending line 1228 when viewed from above (See FIG. 5).

In one embodiment, each of the first and second ball receivable structures 1216, 1216′ have a mouth 1230, 1230′ that opens being aligned approximately 5 degrees forward and approximately 33 degrees behind the longitudinal axis of the elongated shaft, and having at least one of the first and second ball receivable structures 1216, 1216′ offset from a central longitudinally extending axis 1226 and optionally formed offset from a vertically extending axis 1232.

In one embodiment, the multiple ball throwing apparatus 1210 is symmetrical in all regards, regardless of slight variations in the drawing figures that might suggest otherwise. In a particular embodiment, the elongated shaft 1212, and specifically the first flexible upper neck 1214 in relation to the second flexible upper neck 1214′ are symmetrical.

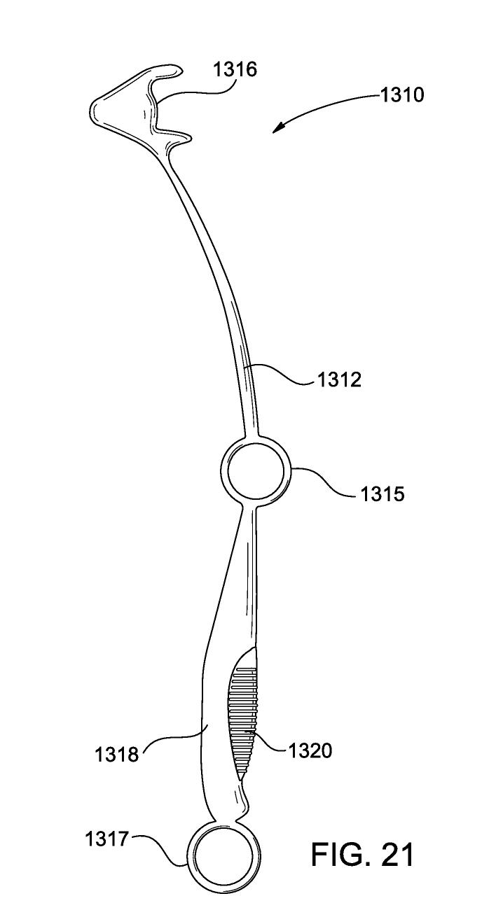

Referring now to an embodiment shown in FIG. 21, side-by-side multiple ball throwing apparatus constructed in accordance with the principles of the present invention and designated generally as multiple ball throwing apparatus 1310. The multiple ball throwing apparatus 1310 comprises an elongated shaft 1312. The unitary elongated shaft 1312 couples a lower handle portion 1318. Integrally formed at the distal end of the elongated shaft 1312 is a first ball receivable structure 1316 and a second ball receivable structure 1316′. At an intermediate location is an intermediate ball retaining portion 1315 operable to maintain a ball therein. The ball may be a standard or non-standard sized tennis ball. Integrally formed at the distal end of the lower handle portion 1318 is a lower ball retaining portion 1317. Operatively, the lower ball retaining portion 1317 optionally maintains a ball therewith when a person throws a ball from any of the first and second ball receivable structures 1316, 1316′ and the lower ball retaining portion 1317 may provide counterbalance, particularly when maintaining a ball thereof aiding in throwing balls from the multiple ball throwing apparatus 1310.

One method of playing the game of fetch with an animal is provided using the following process:
a. selecting an elongated shaft with at least two engagement portions at the distal end of the elongated shaft, each of the at least two engagement portions capable of simultaneously gripping substantially standard sized tennis balls;
b. causing at least one of the two engagement portions to grip at least one substantially standard sized tennis balls
c. gripping a lower portion of the shaft;
d. causing to attach at least two balls to the at least two engagement portions;
e. causing the shaft to swing while holding the lower portion of the shaft; and
f. causing at least one substantially standard sized tennis ball to release from the two engagement portions.

One method of playing the game of fetch with an animal is provided using the following process:
a. selecting an elongated shaft with at least two engagement portions at the distal end of the elongated shaft, at least one engagement portion capable of gripping substantially standard sized tennis ball and at least one engagement portion capable of gripping substantially non-standard sized tennis ball;
b. causing at least one of the two engagement portions to grip at least one either a substantially standard sized tennis ball or a substantially non-standard sized tennis ball;
c. gripping a lower portion of the shaft;
d. causing to attach at least two balls to the at least two engagement portions;
e. causing the shaft to swing while holding the lower portion of the shaft; and
f. causing at least one substantially standard sized tennis ball to release from the two engagement portions.

One method of manufacturing a ball launching apparatus using the following process:
a. causing to form an apparatus, the apparatus terminates on a first end, the first end has a handle capable of gripping, the apparatus terminates on a second end, the second end has two or more receiving portions configured to maintain substantially standard tennis ball shaped objects; and
b. causing to ship the apparatus to a plurality of end users.

One method of manufacturing a ball launching apparatus using the following process:
a. causing to form an apparatus, the apparatus terminates on a first end, the first end has a handle capable of gripping, the apparatus terminates on a second end, the second end has two or more receiving portions configured to maintain substantially standard tennis ball shaped objects; and
b. causing to ship the apparatus to a distributor.

One method of manufacturing a ball launching apparatus using the following process:
a. causing to form an apparatus into a single solid member, the single unitary solid member not constructed using any screws, bolts, or the like, the apparatus terminates on a first end, the first end has a handle capable of gripping, the apparatus terminates on a second end, the second end has two or more receiving portions configured to maintain substantially standard tennis ball shaped objects; and
b. causing to ship the apparatus to a plurality of end users.

One method of manufacturing a ball launching apparatus using the following process:

a. causing to form an apparatus into a single solid member using injection molding, the single solid member not constructed using any screws, bolts, or the like, the apparatus terminates on a first end, the first end has a handle capable of gripping, the apparatus terminates on a second end, the second end has two or more receiving portions configured to maintain substantially standard tennis ball shaped objects;
b. attaching soft gripping members for user comfort and/or aesthetics; and
c. causing to ship the apparatus to a plurality of end users.

While the instant invention discloses throughout two portions for optionally gripping, optionally maintaining, and optionally simultaneously throwing two balls (Exemplary balls 1150, 1151), it is contemplated that more than two portions for the same may be implemented within the spirit and scope of the present invention.

It is within the spirit and scope of the present invention to alter any of the unitary shafts forming a single solid member disclosed herein to a non-unitary telescoping scope shaft that transitions between an extended position for throwing balls and a collapsed position for stowage.

While the instant invention discloses simultaneously throwing of two balls, it is contemplated and within the spirit and scope of the present invention that altering the launch angles of two balls may change the release time of the balls to be not exactly simultaneously, but nevertheless relatively in close proximately in time. Additionally, the term simultaneously may in some instances not mean exactly simultaneous, unless specified otherwise, but instead mean thrown during a single throw.

A unitary shaft as described herein does limit additional components such as adding grip or coupling additional structure, such as soft colored plastic, rubber, or the like for aesthetics with the shaft.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

It is contemplated and intended that features from the various embodiments herein may be optionally combined to arrive at the instant invention.

What is claimed is:

1. A ball throwing apparatus comprising:
an elongated shaft having a longitudinal axis and opposite distal and proximal ends;
a first at least partially spherical structure carried by said distal end;
wherein at least a portion of said ball throwing apparatus illuminates.

2. The ball throwing apparatus of claim 1, wherein said first at least partially spherical structure illuminates in the dark.

3. The ball throwing apparatus of claim 1, wherein said distal end defining a first upper neck, said first upper neck carrying said first at least partially spherical structure.

4. The ball throwing apparatus of claim 1, wherein said distal end defining a first upper neck, said first upper neck carrying said first at least partially spherical structure.

6. A ball throwing apparatus for playing fetch with one or more dogs, the ball throwing apparatus comprising:
an elongated shaft having a longitudinal axis and opposite distal and proximal ends;
a first ball receivable portion carried by said distal end, said first receivable portion operable to capture a ball; and
wherein at least a portion of said ball throwing apparatus is formed of glow in the dark materials.

7. The ball throwing apparatus of claim 6, further comprising an ergonomic handle configured for gripping.

8. The ball throwing apparatus of claim 6, further comprising a non-standard sized object capable of being gripped by said first ball receivable portion.

9. The ball throwing apparatus of claim 6, wherein said first ball receiving portion configured to grip a non-standard sized object.

10. The ball throwing apparatus of claim 6, wherein said glow in the dark materials operable to engage in outdoor fetch in lowlight conditions.

11. The ball throwing apparatus of claim 6, wherein at least a portion of said ball throwing apparatus charges via light.

12. The ball throwing apparatus of claim 6, wherein said longitudinal axis is curved.

13. The ball throwing apparatus of claim 6, wherein said longitudinal axis is straight.

14. The ball throwing apparatus of claim 6, wherein said first ball receivable portion glows in the dark.

15. A method of creating a fetch ball throwing apparatus, the method comprising:
causing to form, via a manufacturing process, a glow in the dark ball throwing apparatus, the glow in the dark ball throwing apparatus terminating on a first end, the first end having a handle capable of gripping, the apparatus terminating on a second end, the second end having at least one receiving portion operable to maintain at least a substantially standard tennis ball shaped object.
